(19) United States
(12) Patent Application Publication
(10) Pub. No.: US 2018/0078866 A1
(43) Pub. Date: Mar. 22, 2018

(54) Sensory Stimulating Developmental Stuffed Animal Pacifier and Teething Toy

(71) Applicant: M SHARON ROGONE, HESPERIA, CA (US)

(72) Inventor: M SHARON ROGONE, HESPERIA, CA (US)

(21) Appl. No.: 15/271,180

(22) Filed: Sep. 20, 2016

(51) Int. Cl. A63H 3/00; A63H 3/02; A63H 3/36; A63H 3/28; A61J 17/02; A61J 17/00

(52) U.S. Cl. CPC A63H 3/003; A63H 3/02; A61J 17/007; A63H 3/28; A61J 17/02; A63H 3/36

(57) ABSTRACT

This is a disclosure related to a device that is for the independent use by an infant or toddler for self-soothing and stimulation of the five senses. This device is designed for the natural needs of infants and toddlers; cognitively, psychologically, and physically. It consists of a small stuffed animal with differing traits and features such as ears and tail to create a variety of animals with a pacifier, teething surfaces and a clip attachment to secure to the child to prevent loss. Inherent in this device are a visually attractive soft animal body and face, a pacifier and teething surfaces with numerous textures, sounds and smells to fill the need to meet all the five sense. The integrity of the device is made to meet all safety standards for toys of the CPSC.

### BACKGROUND

### 1. Field of the Invention

This disclosure is related to a developmentally designed stuffed animal, pacifier and teething toy to be used independently by an infant and/or toddler and is imbued with sensory stimuli, a pacifier and teething surfaces and a clip to secure to child's clothing to prevent loss. More specifically a Sensory Stimulating Developmental Stuffed Animal Pacifier and Teething Toy 100 for independent use by infants and toddlers. It has a basic body 102 and head 104 from which various animals are created by changing the tail 107 and ears 105 or other body part and/or the material used for the fur, a pacifier 203 is attached, as well as teething surfaces 111 and is imbued with sensory stimulation for all five (5) senses: oral (suck/swallow-chewing/gnawing) utilizing a pacifier 203 and teething surfaces 111, auditory (hearing) with a crinkle sound 109 a bells, rattle, squeaker or other noise makers 112, tactile (touch) with numerous textures inclusive of satin-like or other textures like silk or velvet on paws and legs 108 or other body part and various fur-like soft, fluffy and/or fuzzy body 102 or body parts, olfactory (smell) 113 such as soothing lavender secured within the body 102 or other body part and of course, visual appeal (sight) with the overall Sensory Stimulating Developmental Stuffed Animal Pacifier and Teething Toy 100 with various colors and/or shapes 102/110 and the face 106.

### 2. Related Art

Generally non-nutritive sucking is a well-known compulsion and a pacifier 203 with a one piece silicone, TPR or SEBS food grade material is what is recommended by the American Academy of Pediatrics. The necessity for oral (suck/swallow-chewing/gnawing), auditory (hearing), tactile (touch), visual (sight) and olfactory (smell) stimuli, is likewise, well established for nurturing brain development as well as physical growth and the need for teething surfaces for infants and toddlers.

In as much as there are many pacifiers, and even pacifier toys, teething toys and stuffed animals on the market for self soothing, none, meet the advantages comprising the versatile Sensory Stimulating Developmental Stuffed Animal Pacifier and Teething Toy 100.

Pacifiers and their adjuncts have long been in use and have inherently had many diverse problems. Problems such as cleanliness, dropping to the ground, loss, choking hazards, strangulation, injury, etc. Also as the infants grow to toddlers and begin teething new issues and safety problems arise with the integrity of the pacifier, tearing, ripping, breaking or puncturing and/or loose pieces of toys or pacifiers resulting in choking. In addition the lack of developmental stimuli for these infants and maturing toddlers, as they solely focus on the non-nutritive sucking without the option for other stimuli is detrimental, and can lead to sensory and physical exercise deprivation especially when a sole pacifier is used to quiet the child. The purpose of the Sensory Stimulating Developmental Stuffed Animal Pacifier and Teething Toy 100 is to allow for self soothing while safely reducing stress and enriching the mental, psycho-social and over-all growth and development of these infants and toddlers.

### 3. Description

The developmentally designed sensory imbued stuffed animal, pacifier and teething toy for independent use by the child, begins with a pacifier 203 that already meets the CPSC guidelines and recommendations of the American Academy of Pediatrics, but will furthermore meet the guidelines providing for the pull and puncture requirements of the EU or EN 1400 Certification Next it has a basic animal body 102 and head 106 which will compose a variety of soft, fluffy, fuzzy stuffed animals with a change of fur or various body parts 110 or like, that are securely attached to the approved one piece silicone, TPR or SEB pacifier 203 and the attachment clip 201. The developmentally designed sensory imbued stuffed animal, pacifier and teething toy is designed for both independent use for newborn infants and/or infants and toddlers who are teething and with teeth. Inherently, the stuffed animal is augmented with multiple forms of sensory stimuli to enhance the growth and development of the infants and toddlers who use the pacifier toy. Additionally the Sensory Stimulating Developmental Stuffed Animal Pacifier and Teething Toy 100 has an attachment clip 201 which can be safely used to fasten the pacifier-teething toy to the clothing of the infant or toddler for more independent use without fear of strangulation. It has a very short cord, more or less about 2 inches or 6 centimeters that cannot go around the neck. Notice that it is securely attached to a portion of the stuffed animal basic body 102 at one end and the pacifier 203 is safely attached to the other end to prevent accidental loss or dropping to the ground, and is completely machine washable as well, thereby maintaining a cleaner, fresher and healthier pacifier.

The visually charming developmentally designed sensory imbued stuffed animal, pacifier and teething toy provides stimulation for all five senses while being used independently:

visual (1) with the collection of eye pleasing artistic, colorful, and soft stuffed animal bodies 102 and head 104 with their faces 106 to look at, reach for, hold and squeeze,

tactile (2) inclusive of the fuzzy or fluffy texture of the entire basic body 102 but also with the satin (or like) texture 108 of the legs 101 and paws 103, tail 107 and ears 105 and/or any other body parts. In addition the teething surfaces 111 with nubs, bumps, ridges and grooves and also the soft but firm smooth surface of the pacifier 203 and other textures on various other body parts,

auditory (3) with a crinkle sound 109 which can also be inclusive in all or some of the legs 101, paws 103, ears 105, tail 107 or other body parts and/or squeak, rattle and/or bell sounds etc. within the main body 102 or other body parts of the stuffed animal,

olfactory (4) with a lavender or other soothing hypoallergenic fragrance placed within the body 102 or other body parts

oral (5) which includes the pacifier 203 that satisfies and soothes the non-nutritive suck/swallow urge and not to forget the back paws or other body parts enhanced with firmly attached, moderately firm, flexible TPR SEBS or other plastic teething surfaces 111 with nubs, bumps, ridges or grooves for gnawing and chewing to aid in the teething process necessary for infants and toddlers and are inclusive of extra tactile stimuli previously mentioned.

### SUMMARY

Where in, there is a need for a developmental pacifier, teether and/or a pacifier teething toy that can be used independently and stimulate the five senses to enhance growth and development both mentally and physically and be used safely by infants and toddlers who are cutting new teeth. Where in, the Sensory Stimulating Developmental Stuffed Animal Pacifier and Teething Toy 100 inherently has the means to stimulate the five senses, oral (suck/swallow-chewing/gnawing), auditory (hearing), tactile (touch), visual (sight) and olfactory (smell) and provide for non-nutritive sucking, as well as, surfaces for teething and be used independently and physically challenge the child to reach for, hold and squeeze the toy. When these can be inclusive in a variety of visually pleasing, soft and cuddly stuffed animals as well as have the advantage of a safe means to prevent dropping to the ground to become lost or dirty, and, is also completely machine washable to maintain cleanliness, the need for this diverse independent developmentally designed sensory imbued stuffed animal, pacifier and teething toy is apparent.

In order to enhance the psycho-social, physical and mental development for infants and toddlers there is a need to provide positive stimuli in their environment in addition to self south and reduce stress with safe non-nutritive sucking and teething surfaces to reduce the discomfort from cutting new teeth. The Sensory Stimulating Developmental Stuffed Animal Pacifier and Teething Toy 100 addresses these issues and more with oral satisfaction, chewing and gnawing surfaces and textures, sights, sounds and smells to meet all these needs with a visually delightful, colorful, soft fuzzy stuffed animal inclusive of; a pacifier 203, teething surfaces 111, various tactile stimuli, multiple sounds 112 and even smells 113. The stuffed animals is fixed firmly to both the pacifier 203 and to the attachment clip 201 which is used to fasten to the clothing of the infants and toddlers facilitating independent use.

These and other features and advantages of the present invention will be more readily apparent from the drawings FIGS. 1, 2 and 3 of the Sensory Stimulating Developmental Stuffed Animal Pacifier and Teething Toy 100 along with the specifications set forth below and taken in conjunction with the accompanying drawings.

### BRIEF DESCRIPTION OF THE DRAWINGS

The present invention may be better understood, and its numerous objects, features, and advantages made apparent to those skilled in the art by referencing the accompanying drawings.

FIG. 1 is a simplified view of the basic body 102 and head 104 of the Sensory Stimulating Developmental Stuffed Animal Pacifier and Teething Toy 100 without adornment of various animal traits but inclusive of the added teething surfaces, the clip, and the pacifier in accordance with the embodiment of the present invention.

FIG. 2 is a detailed plan view of FIG. 1 depicting basic body with the addition of ears and tail traits of one animal and the sensory imbued attributes all safely embroidered, attached or sewn securely to and or within the basic body 102 and head 104 or other part.

FIG. 3 is a detailed plan view of FIGS. 1 and 2 depicting the traits in shadow of various animals to demonstrate the diversity possible with the basic body 102 and head 104 shape.

### DETAILED DESCRIPTION OF THE DRAWING

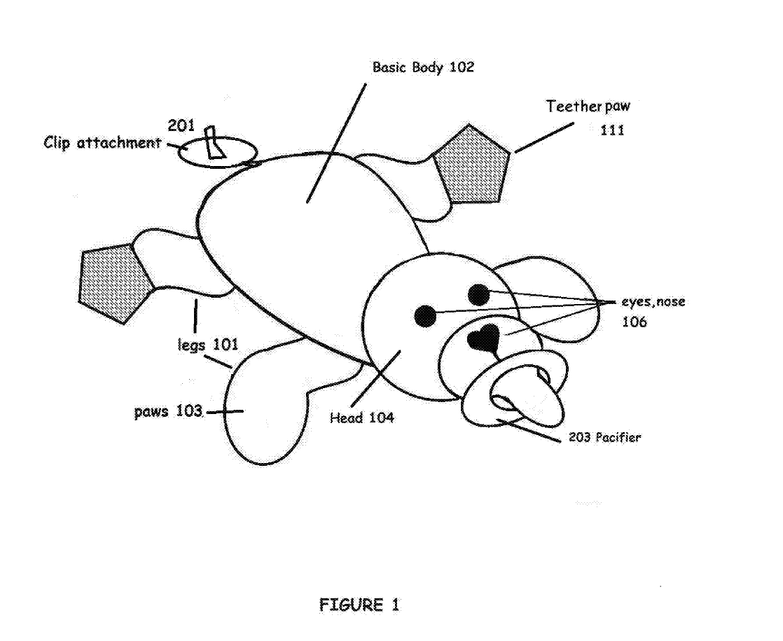

FIG. 1 is a simplified view showing the Sensory Stimulating Developmental Stuffed Animal Pacifier and Teething Toy 100 and its basic elements, the shape of the stuffed animals basic body 102, the shape of the stuffed animal head 104, also denoting the legs 101 and front paws 103, the face with eyes, nose and mouth 106, safely printed, stitched or embroidered and the safely attached teething surfaces 111 as back paws, the clip 201 to attach pacifier 203 to child's clothing or belongings in accordance with the embodiment of the present invention.

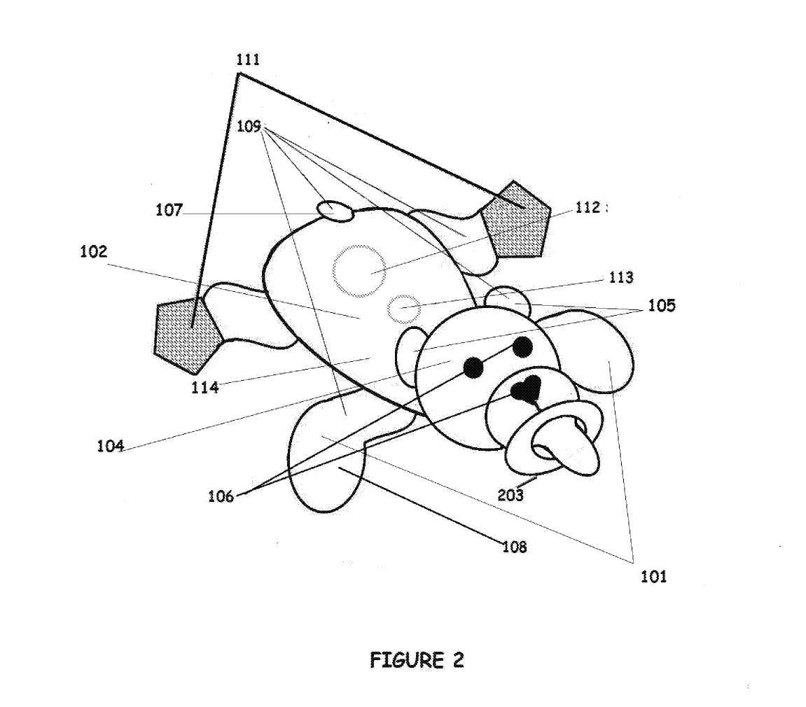

FIG. 2 is a detailed plan view of the Sensory Stimulating Developmental Stuffed Animal Pacifier and Teething Toy 100 of FIG. 1 indicating more details of the unique elements for various sensory stimuli. The visual stimuli of the stuffed animal is apparent with the body 102 and head 104 and face 106. The pacifier 203, is a one piece silicone, TPR or SEBs pacifier/oral soother, for non-nutritive suck and oral stim, is shown securely attached at the mouth or chin of stuffed animal. The paws all or some can be made from flexible, semi-soft durable TPR, SEBs or plastics material with nubs, bumps and ridges or grooves for teething surfaces 111 for gnawing and chewing and generalized oral satisfaction as well as tactile stimuli for infants and/or toddlers. Additional tactile stimuli is the basic body 102 and head 104 made from a variety of fur like textured fabrics and the legs 101, tail 107 and ears 105, all and/or some, can be made from a differing fabric such as satin or other textured fabric 108, as well as, crinkly material 109, shown in front the legs 101, tail 107 and ears 105 may also be positioned within any body part for auditory as well as tactile stimuli. In addition other auditory stimuli 112 and olfactory stimuli 113 may be sewn within the main basic body 102, head 104 or other part body. Plus the attachment clip 201 can be securely attached to any part of the animals basic body 102 with a short, strong cord or ribbon approximately 2 inches or 6 centimeters in length to fasten to infant's or toddler's clothing without chance of strangulation.

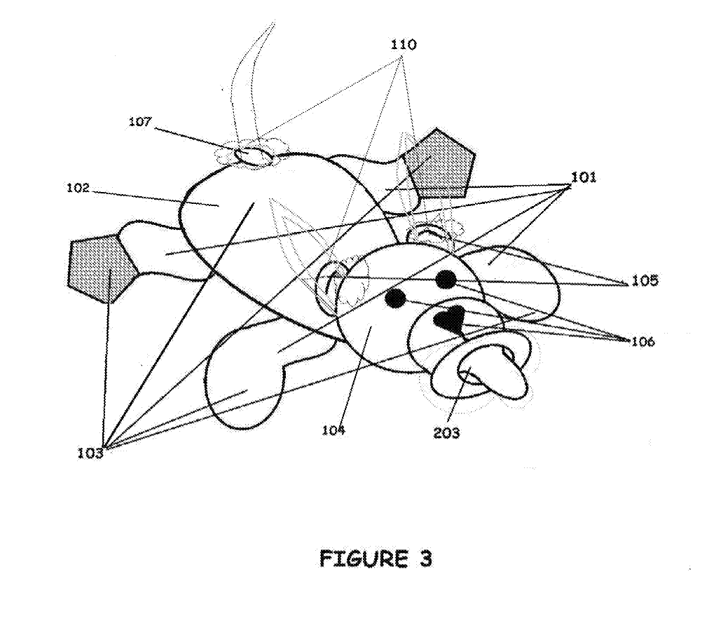

FIG. 3 is a detailed plan view of the Sensory Stimulating Developmental Stuffed Animal Pacifier and Teething Toy 100 of FIGS. 1 and 2 inclusive of the body 102, head 104, legs 101, paws 103, ears 105 and tail 107 indicating the possibilities for changing the details of the unique elements for animal traits 110, shown in shadow, with inter-changeable ears 105 and tail 107, to embody additional diversity of animal types, as well as inherent sensory stimuli. Also demonstrated in shadow is the possibility for differing pacifiers to be used.

1. A Sensory Stimulating Developmental Stuffed Animal Pacifier and Teething Toy 100 designed for independent use by an infant or child and is inclusive of: a stuffed animal body and head with various traits, in many different colors, with several differing fur textures and other textures such as a satin like texture for the some of the body parts.
Additionally a smooth pacifier, textured teething surfaces, fragrance, and various sound makers to stimulate all five senses (oral, olfactory, auditory, touch, visual).
And a securely attached clip to safely fasten to infant or toddler clothing.

2. The sensory toy of claim 1 comprises stimuli for the five senses:
Visual stimuli with the face eyes, nose and mouth safely printed, stitched or embroidered on the head, a feature eliminating loose parts or pieces that could break or fall off and present a choking hazard and the very soft, stuffed, rounded animal body; both with various traits and colors to depict a variety of animals
Tactile stimuli with textures of the differing materials used: fur like fabric for the fuzzy basic body and head and satin or other textures for the legs and ears or other, with the firm but flexible surfaces with bumps, grooves and ridges from plastics, TPE, TPR or SEBs and the soft silicone TPR, of the pacifier, for a smooth, soft surface, as well as, the soft and squeezable polyester filling in the basic body along with other textures and parts.
Auditory stimuli: a crinkle sound, a bell, squeaker or rattle sounds secured within the basic body, the tail, ears, legs, paws, and/or any other body part.
Olfactory stimuli with a safe and soothing lavender or other hypo-allergenic fragrance secured within the basic body or other body part.
Oral stimuli with a pacifier for non-nutritive sucking/swallow contentment and the teething surfaces providing for gnawing and chewing comfort and satisfaction during the teething process for independent use by infants and/or toddlers.

3. The sensory toy of claim 1, comprises a developmentally designed sensory imbued stuffed animal, pacifier and teething toy constructed from superior and safe materials. The sensory toy of claim 1, comprises a construction as follows:
The basic body and head comprises both exterior material and inner stuffing all made of cotton, polyester or cotton-poly fabric materials.
The pacifier is CPSC and EN 1400 certified, comprises a construction of one piece, silicone, SEBS, or TPR.
An attachment clip comprises plastic or TPE, with a spring type mechanism used to fasten to clothing and a short ribbon or cord, approximately 2 inches or 6 centimeters, made of polyester, nylon or cotton to secure the attachment clip to the basic body.
The teething surfaces comprises a strong, flexible and medium soft but very durable plastic, TPE, TPR, or SEBs with bumps, grooves and/or ridges and are secure to the basic body or body part.
The changeable parts ears, tail, legs, paws, and/or other parts have a construction of several different kinds of textured fabrics made of polyester, nylon, cotton or blends of materials and/or other parts made from TPE, plastic or SEBs.
All additional squeakers, rattles and noise makers are of a SEBs, TPN, TPE, or other plastics.
The olfactory smell is an organic hypo allergenic fragrance.
